(19) United States
(12) Patent Application Publication
(10) Pub. No.: US 2022/0399560 A1
(43) Pub. Date: Dec. 15, 2022

(54) BIOELECTROCHEMICAL SYSTEM FOR TREATMENT OF ORGANIC LIQUID WASTES

(71) Applicant: OKINAWA INSTITUTE OF SCIENCE AND TECHNOLOGY SCHOOL CORPORATION, Okinawa (JP)

(72) Inventors: Viacheslav FEDOROVICH, Okinawa (JP); Igor GORYANIN, Okinawa (JP); Tomoharu INOUE, Okinawa (JP)

(73) Assignee: OKINAWA INSTITUTE OF SCIENCE AND TECHNOLOGY SCHOOL CORPORATION, Okinawa (JP)

(21) Appl. No.: 17/633,283

(22) PCT Filed: Aug. 7, 2020
(86) PCT No.: PCT/JP2020/030314

§ 371 Date: Feb. 7, 2022

(30) Foreign Application Priority Data
Aug. 9, 2019 (JP) 2019-147858

(51) Int. Cl. H01M 8/16; C02F 3/00; H01M 8/0245; H01M 8/0252; H01M 4/86; H01M 4/90; H01M 4/96

(52) U.S. Cl. CPC H01M 8/16; C02F 3/005; H01M 8/0245; H01M 8/0252; H01M 4/8657; H01M 4/9083; H01M 4/96; H01M 4/9041; C02F 2201/46; C02F 2203/006; H01M 2004/8684; H01M 2004/8689

(57) ABSTRACT

The present invention relates to a bio electrochemical system for the treatment of organic liquid wastes. The bio electrochemical system comprises a container; at least one tube shaped separator vertically disposed such that it penetrates the container; at least one anode disposed in the external space of the tube shaped separator; at least one cathode disposed in the interior space of the tube shaped separator; and at least one partition plate horizontally disposed such that it forms multistage horizontal flow channels for organic liquid wastes in the container.

### TECHNICAL FIELD

The present invention relates to a bio electrochemical system for treatment of organic liquid wastes.

### BACKGROUND ART

Bioelectrochemical systems (BES) or microbial fuel cells (MFC) are devices, which utilize bacteria as catalysts to create useful products, such as electricity and some other. The BESs are of great interest because they are capable of generation of sustainable energy especially in wastewater treatment (Non-patent literature 1-4).

### CITATION LIST

Non Patent Literature 1: B. E. Logan, J. M. Regan, Environ. Sci. Technol. 40 (2006) 5172-5180.

Non Patent Literature 2: B. E. Rittmann, Trends Biotechnol. 24 (2006) 261-266.

Non Patent Literature 3: B. Min, B. E. Logan, Environ. Sci. Technol. 38 (2004) 5809-5814.

Non Patent Literature 4: B. Min, J. R. Kim, S. Oh, J. M. Regan, B. E. Logan, Water Res. 39 (2005) 4961-4968.

### SUMMARY OF INVENTION

### Technical Problem

However, electrode configurations for BES often limit power production and figure prominently in space constraints associated with fuel cells. Thus, there is a need for development of scalable electrodes and scalable electrode assembly configurations for BES.

The purpose of the present invention is to provide a scalable electrode assembly configuration for BES and a scalable BES (or microbial fuel cell).

### Solution to Problem

In order to achieve the above object, the present invention provides the following.

(1) A bio electrochemical system for the treatment of organic liquid wastes, which comprises:

a container;
at least one tube shaped separator vertically disposed such that it penetrates the container;
at least one anode disposed in the external space of the tube shaped separator;
at least one cathode disposed in the interior space of the tube shaped separator; and
at least one partition plate horizontally disposed such that it forms multistage horizontal flow channels for organic liquid wastes in the container.

(2) The bio electrochemical system according to (1), wherein the cathode is an air cathode.

(3) The bio electrochemical system according to (1) or (2), wherein the cathode is disposed in contact with the inner surface of the tube shaped separator.

(4) The bio electrochemical system according to any one of (1) to (3), wherein the anode is disposed vertically such that it crosses the multistage horizontal flow channels.

(5) The bio electrochemical system according to any one of (1) to (4), which further comprises a liquid inlet and a liquid outlet.

(6) The bio electrochemical system according to any one of (1) to (5), which further comprises a wetting unit for the cathode.

(7) The bio electrochemical system according to any one of (1) to (6), which further comprises an oxygen supplying unit for the cathode.

(8) The bio electrochemical system according to any one of (1) to (7), wherein the volume of the container is more than 1 m³ and the shape of the container is parallelepiped.

(9) The bio electrochemical system according to any one of (1) to (8), wherein upper lid and bottom part of the container have holes for installation of the tube shaped separator.

(10) The bio electrochemical system according to any one of (1) to (9), wherein the partition plate contains a hole for keeping the tube shaped separator and the anode in vertical position, wherein the partition plate has a window for entering of the liquid from one flow channel to the next flow channel.

(11) The bio electrochemical system according to (10), which comprise two or more of the partition plate with a window formed against one wall of the container, wherein the wall surface on which the window of one of the partition plate is formed and the wall surface on which the window of the other partition plate disposed next to the partition plate is formed are in an opposing relationship.

(12) The bio electrochemical system according to (10) or (11), wherein all edges, except window edges, of the partition plate have water proof contact with all four walls of the container.

(13) The bio electrochemical system according to any one of (1) to (12), which further comprises a catalyst attached to the cathode.

(14) The bio electrochemical system according to (13), wherein the catalyst consists of a porous electrically conductive support material covered by a catalytically active compound containing atom of transition metals.

(15) The bio electrochemical system according to (14), wherein the porous electrically conductive support material is a granule of carbon-based material.

(16) The bio electrochemical system according to (15), wherein the granule of carbon-based material is a highly porous granule of activated carbon.

(17) The bio electrochemical system according to any one of (13) to (16), wherein the catalytically active compound is represented by the general formula [Metal]ₓ[Nitrogen]_{y}[Carbon]_{z}.

(18) The bio electrochemical system according to any one of (1) to (17), wherein the tube shaped separator comprises a porous supporting material and a cation exchange material.

(19) The bio electrochemical system according to (18), wherein the porous supporting material is a nonconductive porous material.

(20) The bio electrochemical system according to any one of (1) to (19), wherein the tube shaped separator is cylindrical.

(21) The bio electrochemical system according to any one of (1) to (20), wherein the tube shaped separator has two open ends.

(22) The bio electrochemical system according to any one of (18) to (21), wherein the cation exchange material is a cation exchange polymer.

(23) The bio electrochemical system according to any one of (18) to (22), wherein the cation exchange material is introduced in pores of the porous supporting material.

(24) The bio electrochemical system according to (22) or (23), wherein the cation exchange polymer is a polymer selected from the group consisting of Nafion™ type polymers, Fumion™ type polymers and a double network hydrogel which contains negatively charged groups.

(25) The bio electrochemical system according to any one of (1) to (24), wherein the cathode is a soft conductive material selected from the group consisting of carbon tissue, carbon felt and carbon paper.

(26) The bio electrochemical system according to any one of (1) to (25), wherein the cathode is attached to the inner surface of the tube shaped separator.

(27) The bio electrochemical system according to any one of (1) to (26), wherein the catalyst is attached to the air faced surface of the cathode.

(28) The bio electrochemical system according to any one of (13) to (27), wherein the wetting unit periodically wets the cathodes with electrolyte such that a wet contact between the inner surface of the tube shaped separator and the cathode and a wet contact between the cathode and the catalyst are maintained.

(29) The bio electrochemical system according to any one of (13) to (28), wherein the wetting unit comprises a pipe for supplying electrolyte and a cap having a sprayer for spraying the supplied electrolyte, wherein the sprayer introduces the electrolyte only to the inner surface of the tube shaped separator.

(30) The bio electrochemical system according to (29), wherein the cap having the sprayer is located at the top point of the tube shaped separator, wherein the sprayed electrolyte forms a wall flow near the inner surface of the tube shaped separator using the cathode as a guiding element and comes down to the bottom point by gravity.

(31) The bio electrochemical system according to any one of (7) to (30), wherein the oxygen supplying unit comprises an air collector and an airflow stimulator.

(32) The bio electrochemical system according to (31), wherein the air collector is box shaped and is disposed such that it covers the top of all the tube shaped separators, wherein the bottom part of the air collector collects gas from the inside of the tube shaped separator.

(33) The bio electrochemical system according to (32), wherein the airflow stimulator is a fan which disposed either on the side walls or on the top of the box shaped air collector.

(34) The bio electrochemical system according to (32), wherein the air flow stimulator is a hollow tube of at least 6 times higher than the height of the container with open ends, wherein the hollow tube stands vertically on the top of the air collector and communicates with the air collector at one end.

(35) The bio electrochemical system according to any one of (1) to (34), wherein anode comprises a conductive core with or without a carbon based element attached to the conductive core.

(36) The bio electrochemical system according to (35), wherein the anode comprises at least one selected from the group consisting of a stainless steel rod, a stainless steel brush, a carbon rod, and a carbon brush.

(37) The bio electrochemical system according to any one of (1) to (36), wherein at least one of the anodes is disposed on the outer surface of the tube shaped separator with no gap.

(38) The bio electrochemical system according to (37), wherein at least one of the anodes is reeled up on a part of the outer surface of the tube shaped separator.

(39) The bio electrochemical system according to (37), wherein at least one of the anodes is in the form of straight line.

### Advantageous Effects of Invention

The present invention can provide a scalable BES (or microbial fuel cell).

### BRIEF DESCRIPTION OF DRAWINGS

FIG. 1 is a schematic view showing the BES according to the Embodiment 1.

FIG. 2 shows the tube shaped separator of the BES according to the Embodiment 1. FIG. 2A is a plan view of the tube shaped separator. FIG. 2B is a cross-sectional view of the tube shaped separator taken from the line I-I in FIG. 2A.

FIG. 3 is a schematic view showing the modification of the BES according to the Embodiment 1.

FIG. 4A is a graph showing the changes of BES voltage when the number of working cathodes is decreasing. FIG. 4B is a graph showing the changes of BES current when the number of working cathodes is decreasing. FIG. 4C is a graph showing the changes of BES total cathodic potential when the number of working cathodes is decreasing. FIG. 4D is a graph showing the changes of BES total anodic when the number of working cathodes is decreasing.

FIG. 5 is a graph showing the concentration of ammonia, which was washed out from the surface of two groups of cathodic electrodes VS the BES current.

FIG. 6 is a graph showing the evolution of TE and OLR for HRT=8 days.

FIG. 7 is a graph showing the evolution of TE and OLR for HRT=5 days.

FIGS. 8(A-C) show the results of electrochemical tests for the cation exchange separators and cation exchange membrane.

FIGS. 9(A-B) show the results of internal resistances tests for the cation exchange separators.

### DESCRIPTION OF EMBODIMENTS

In the present invention, bioelectrochemical system (BES) means a device capable of converting chemical energy into electrical energy (and vice-versa) while employing microorganisms as catalysts, the BES of the present invention may be, for example, a microbial fuel cell (MFC), a microbial electrolysis cell (MEC) and the like, preferably a microbial fuel cell (MFC).

Next, an embodiment of the present invention will be described using the drawings. The present invention is not limited at all by the following embodiments. In the drawings, the same parts are denoted by the same reference numerals. Further, in the drawings, for convenience of explanation, the structure of each part may be appropriately simplified and the dimensional ratio of each part may be schematically shown differently from the actual one.

### Embodiment 1

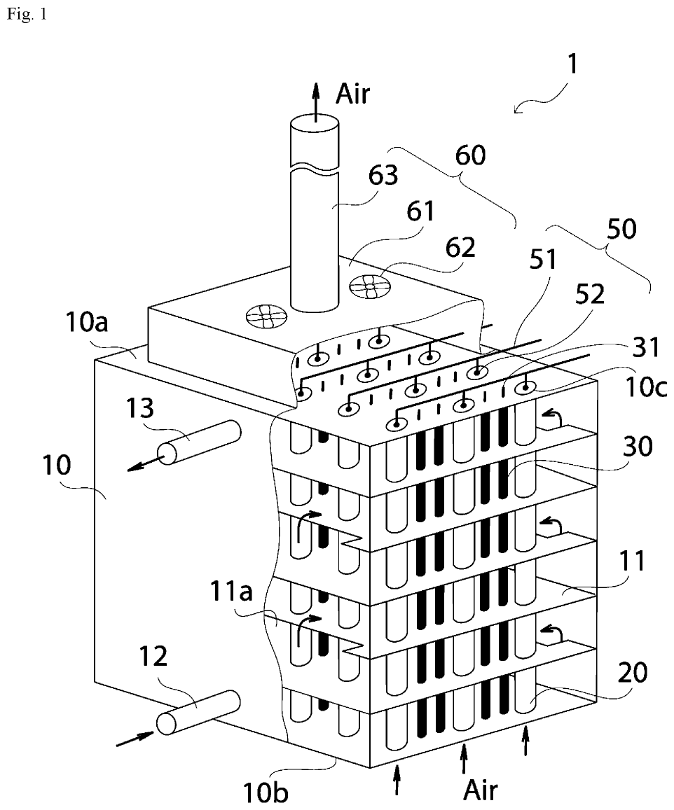

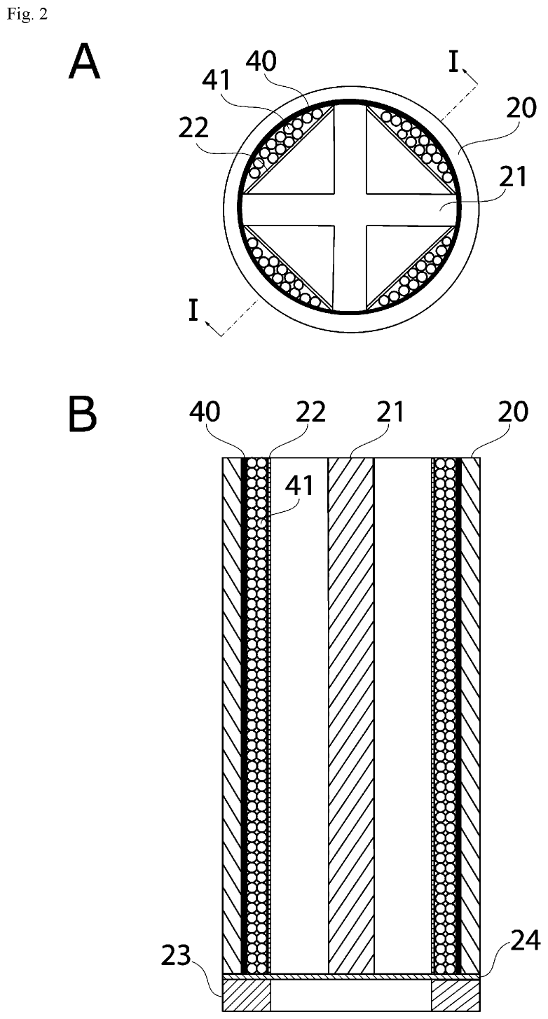

FIG. 1 shows an embodiment of the BES of the present invention and FIG. 2 shows the tube shaped separator of the BES. The BES (1) has the container (10) (also called a reactor) which is in the form of parallelepiped. In the present invention, the container can be scaled up to, for example, more than 1 m³. The container (10) has tube shaped separators (20). Each the tube shaped separator (20) is vertically disposed such that it penetrates the container (10). Here, the upper lid (10a) and the bottom part (10b) of the container (10) have holes (10c) for installation of each the tube shaped separator (20). Each the tube shaped separator (20) penetrates through the holes (10c), thus, is fixed vertically to the container (10). In the BES (1), the anodes (30) are disposed in the external space of the tube shaped separators (20) and the cathodes (40) are disposed in the interior space of the tube shaped separator (20) (the specific explanation will be described later). Thus, the anodic zone is formed in the external space of the tube shaped separator (20) and the cathodic zones are formed in the interior space of the tube shaped separator (20). In the present embodiment, the tubed shaped separator (20) is cylindrical (round tube shaped). However, the shape of the tubed shaped separator is not limited thereto, it may be any type of shape including prismatic (square tube shaped).

Furthermore, the BES (1) has five partition plates (11). Each partition plates (11), which has a rectangular shape, is horizontally disposed in the container (10), thus the anodic zone is sectionalized into six sections by the partition plates (11). Each partition plate (11) has rounded holes for keeping the tube shaped separator (20) and the anodes (30) in vertical position. Each partition plate (11) also has one window (11a) formed against one wall of the container (10) for entering of organic liquid wastes from the section located below. The windows of every two partition plates are arranged such that the wall surface on which one window is formed and the wall surface on which the other window is formed are in an opposing relationship. The edges of each partition plate (11) (except window (11a)) are covered with special seal to have a waterproof contact with all four walls of the container (10). Moreover, one of the side parts of the container (10) has the liquid inlet (12) for introduction of organic liquid wastes (e. g. wastewater) to the lowest section and the liquid outlet (13) for the removal of discharged wastewater from the top section. In this way, the anodic zone sectionalized by five partition plates (11) in the container (10) forms six horizontal flow channels for organic liquid wastes. Here, the BSE (1) shown in FIG. 1 has five partition plates, but the number of partition plates that the BSE of the present invention has is not limited, the BSE may have any number of partition plates.

The BES (1) has multistage horizontal flow channels in the container (10). The liquid flow inside each flow channel is horizontal, and it is vertical when liquid is entering an upper flow channel from the below flow channel through the window (11a) of the partition plate (11). Here, the division of the anodic zone into sections (i.e. multistage horizontal flow channels) makes it possible to increase the total pathway of organic liquid wastes and the leaner velocity of the liquid flow whilst keeping constant the volumetric flow rates. This can improve mass transport properties in the anodic zone of the BES (1).

The tube shaped separator (20) in the present embodiment have a cylindrical form with two open ends, the tube shaped separator (20) separates a liquid phase of anodic zone and a gas phase of cathodic zone. The tube shaped separator (20) is made of porous ceramic in the form of the tube where porous system is filled by cation exchange polymer. The external surface of the tube shaped separator (20) is faced to the liquid phase of anodic zone while the internal surface of the tube shaped separator (20) which contains elements of air cathode (40) is faced to a gas phase.

In the present invention, as the tube shaped separator (20), a separator comprising a porous supporting material (e.g. a porous ceramic) and a cation exchange material (e.g. cation exchange polymer) can be preferably used. Here, a cation exchange material may be a Nafion™ type polymer (e.g. Nafion 117 (Dupont corp. USA)), a Fumion™ type polymer (e.g. Fumion 1005 (Fumatech corp. Gemany)), a hydrogel which contains negatively charged groups and the like. And a cation exchange material is introduced in pores of the porous supporting material. Such separator can reduce a possibility of substrate loss and biofouling on the cathode by increased oxygen penetration, which can create aerobic biological activity. This character of the separator could be especially true with complex substrates and/or wastewaters that are degraded by different trophic groups, because the oxic or anoxic interface on air cathodes can be a favorable environment for bacterial consortia. Thus, the separator mentioned above which can suppresses biofilms on the cathodes inhibiting the cathodic reduction reaction is preferably used.

The porous supporting material may be preferably a nonconductive porous material (e.g. a porous ceramic). When the porous supporting material is a nonconductive porous material, the anode can be disposed very close to the outer surface of the tube shaped separator without a problem of short cut circuit between anode and cathode.

In addition, in the present invention, as the tube shaped separator, a separator comprising a porous supporting material and a hydrogel, wherein the hydrogel is introduced in pores of the porous supporting material, can also be preferably used. The specific explanation will be described later.

The cathodes (40) in the present embodiment are air cathodes. The cathode (40) is disposed in contact with the inner surface of the tube shaped separator (20). Each of the cathodes (collector of electricity part) (40) is attached to the catalyst (41) for enhancing of electrochemical oxygen reduction reaction. However, the cathode of the present invention is not limited, a conventionally known and commonly used cathode for air cathodes can be used.

The upper lid (10a) of the BES contains electrical outputs (31) of anodic electrodes (30). The upper part of cathodic electrodes (40) is adjacent to the holes (10c) in the upper lid of the BES. The anode (30) and the cathode (40) are connected by an external circuit (not shown).

The catalyst (41) consists of a highly porous granule of activated carbon covered by a catalytically active compound containing atom of transition metals. However, the catalyst of the present BES is not limited thereto, a conventionally known and commonly used catalyst for enhancing of electrochemical oxygen reduction reaction can be used. In particular, a catalyst consisting of a porous electrically conductive support material covered by a catalytically active compound containing atom of transition metals is preferably used. The porous electrically conductive support material may be a plurality of granules of carbon-based material, which has sufficiently large surface area. The catalytically active compound, which covers the surface of the porous electrically conductive support material, is represented by the general formula [Metal]ₓ[Nitrogen]_{y}[Carbon]_{z}.

The cathode (collector of electricity part) (40) is attached to the inner surface of the tube shaped separator (20). As the cathode (collector of electricity part) (40), a soft conductive material, preferably a soft conductive material selected from the group consisting of carbon tissue, carbon felt and carbon paper, can be used.

The catalyst (41) is mechanically attached to the air-faced surface of the cathode (collector of electricity part) (40) by means of polymeric net (22). The polymeric net (22) is attached to the holder (21) with cross section in the form of a cross. The shape of the holder (21) makes possible the creation of four hollow zones inside the internal part of cathodic zone for the creation of vertical airflow. The bottom part of the separator (20) is attached to the nonconductive ring (23). The nonconductive net (24) in the form of the circle is inserted between the upper part of the ring (23) and the bottom part of the tube shaped separator (20) and held by them so as to keep the catalyst (41) and the holder (21) in a fixed position.

In the present embodiment, the anodes (30) are disposed vertically in parallel such that it crosses the multistage horizontal flow channels and the upper lid (10a). Here, the anodes (30) and the tube shaped separator (20) can be disposed with or without some gap between them. In the BES of the present invention, there is no need to locate the anodes (30) and the separator (20), on the inner surface of which the cathode is disposed, apart. Thus, the BES can increase the number of anodes placed per unit volume.

The anode of the present invention is not limited, a conventionally known and commonly used anode can be used. For example, as the anode, an anode has a conductive core with or without a carbon based elements attached to the conductive core can be used. In more details, a stainless steel rod, a stainless steel brush, a carbon rod, a carbon brush can be used as the anode. Preferably, a carbon brush or a stainless steel brush can be used because they have big surfaces.

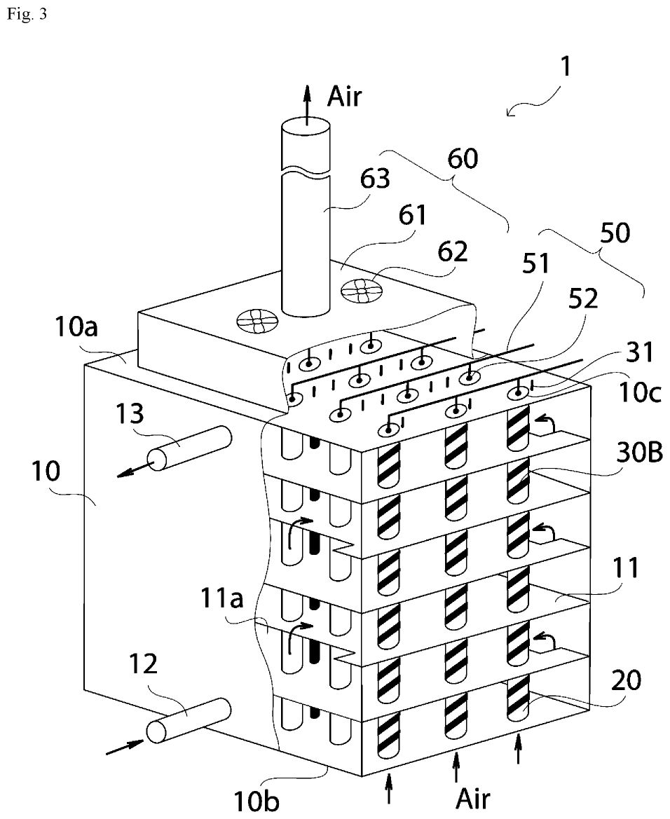

In the BES of the present invention, other different types of mutual arrangement of anode and cathode (separator) can be realized using design and parts of present disclosure. In particular, the anode can be disposed on the outer surface of the tube shaped separator with no gap. For example, the anode may be disposed on the outer surface of the tube shaped separator in the form of straight line parallel the tube shaped separator with no gap; the anode may be reeled up on the outer surface of the tube shaped separator; and the anode may be reeled up on a part of the outer surface of the tube shaped separator and disposed on another part of the outer surface of the tube shaped separator in the form of straight line. The arrangement of anodes and cathodes like these can decreases the internal resistance of the BES, because the anode and the cathode don't have some gap between them. The modification of the BES wherein some of the anodes (30B) is reeled up on the outer surface of the tube shaped separator (20) are shown in FIG. 3.

In the BES of the present invention, for example, depending on the type of organics, different types of anaerobic microorganisms can be used. For complex organics, BES may contain several classes of bacteria: fermentative bacteria, acidogenic bacteria and electrogenic bacteria. Different types of bacteria can belong to these classes. To prepare BES for working mode the last one should be inoculated with a sludge which contains all classes of these bacteria. Then inappropriate bacteria will be washed out in continuous flow mode.

In the present embodiment, the BES (1) has the wetting unit (50) for cathode. The wetting unit (50) has the pipes (51) for supplying electrolyte, the caps (52) which has the sprayers (not shown) inside it. Here, the pipes (51) pass through the sidewall of the air collector (61), which is attached to the upper lid (10a) of the container (10). The caps (52) are located at the top point of every tube shaped separator (20), the sprayers are located in the center of the holes of the separator (20). The sprayer periodically sprays the supplied electrolyte into the cathode (40) on the inner surface of the tube shaped separator (20). The sprayed electrolyte is coming down to the bottom point by gravity using the cathode (collector of electricity part) (40) as a guiding element, and forms a wall flow near the internal surface of the tubed shaped separator (20). In this way, a wet contact between the inner surface of the tube shaped separator (20) and the cathode (collector of electricity part) (40) and a wet contact between the cathode (collector of electricity part) (40) and the catalyst (41) are maintained. In the present embodiment, the BES is scaled up and the cathode is easy to dry. Thus, the forcible supplying of electrolyte can be preferably used to control the amount of electrolyte and effectively wet the cathodes of the BES (in contrast, the transportation of electrolyte based on capillary action doesn't work for scaled up BES with the size more than 1 m³ because the rate of wetting of cathode is slow than the rate of the evaporation on cathode). Furthermore, the forcible supplying of electrolyte can wash the accumulations of cations (sodium ion, potassium ion, ammonium ion and the like) on the inner surface of the tube shaped separator. This can prevent the pH shift to alkaline in the cathodic zone.

In the present embodiment, the BES (1) has the oxygen supplying unit (60) for cathode. The oxygen supplying unit (60) has the air collector (61) and the fans (62) as the airflow stimulator. The air collector (61) is box shaped without bottom part. The box shaped air collector (61) is attached to the upper lid (10a) so that it covers the tops of all the tube shaped separators (20) and collects gas from the inside of the tube shaped separators (20). The box shaped air collector (61) also has the fans (62) on the top of it. Here, in the embodiment, while the fans are located on the top of the box shaped air collector (61), the location of the fans (62) is not limited thereto, the fans (62) may be located on the side walls of the box shaped air collector (61). The oxygen supplying unit (60) can improve the efficiency of ventilation, which is very important for large scale BESs. Especially, the arrangement of the oxygen supplying unit (60) can produce the same air pressure at all the tops of the tube shaped separators (20), which results in the same air fluxes at the air cathodes.

In the embodiment, in addition to the fans (62), the hollow tube (63) is also used as the air flow stimulator. The hollow tube (63) is of at least 6 times higher than the height of the container (10) and has two open ends, which stands vertically on the top of air collector (61) and communicates with the air collector (61) at one end. The hollow tube (63) suck up the gas from the air collector (61) at one end and release it at another end due to the difference of pressure at the opposite ends of the hollow tube (63). While both the fans (62) and the hollow tube (63) are used in the present embodiment, either the fans (62) or the hollow tube (63) may be used alone.

<Separator>

In the present invention, as the tube shaped separator, the separator comprising a porous supporting material and a hydrogel, wherein the hydrogel is introduced in pores of the porous supporting material can be preferably used. The porous supporting material is tube shaped.

This separator is characterized in that a hydrogel is introduced in pores of a porous supporting material. Because the hydrogel can swell in pores of the porous supporting material, for example, the hydrogel can completely cover the surface of the separator, and the hydrogel can make contact with the cathode and interacts readily with the volume of organic liquid wastes. Furthermore, this character of this separator can protects the separator from pressing out of the hydrogel from the porous supporting material.

(Porous Supporting Material)

In this separator, the porous supporting material can be any hydrophilic material as long as it is enough rigid to support the hydrogel and has pores which the hydrogel can be introduced into.

The porous supporting material includes porous graphite (after hydrophilization), porous glass, porous stainless-steel, porous ceramics and the like, preferably porous ceramics.

(Hydrogel)

In the present invention, the hydrogel means a hydrophilic polymer containing a large amount of water. This separator comprises a hydrogel.

The hydrogel may have, for example, an interpenetrating polymer network (IPN). In the case of the hydrogel having an interpenetrating polymer network, the hydrogel has high mechanical strength. Furthermore, the hydrogel may possess cation exchange properties. Because the hydrogel can exchange cations, the separator can repress depolarization.

In the present invention, the interpenetrating polymer network means a polymer comprising two or more networks that are at least partially interlaced on a molecular scale but not completely covalently bonded to each other and cannot be separated unless chemical bonds are broken. The interpenetrating polymer network (IPN) is distinguished from a semi-interpenetrating polymer network (semi-IPN) which is a polymer comprising one or more polymer networks and one or more linear or branched polymers characterized by the penetration on a molecular scale of at least one of the networks by at least some of the linear or branched macromolecules. These definitions further distinguish a semi-interpenetrating polymer network (semi-IPN) from an interpenetrating polymer network (IPN) by the fact that the former is a mixture of a polymer and a polymer network which can be separated by physical means. The polymeric crosslinking which occurs during the formation of an interpenetrating polymer network entangles the constituent polymers in such a manner that they can only be separated by breaking chemical bonds.

In the present invention, a polymer network which the interpenetrating polymer network (IPN) comprises may be at least two or more polymer networks. One of the polymer networks may be, for example, formed by polymerization of negatively charged monomers, and occasionally crosslinking by a cross-linker. In the case of one of the polymer networks is formed by polymerization of negatively charged monomers, the hydrogel possesses cation exchange properties.

The negatively charged monomers includes acrylic acid, methacrylic acid, 2-acrylamido-2-methylpropanesulfonic acid and the like, preferably 2-acrylamido-2-methylpropanesulfonic acid.

In the present invention, one of the polymer networks may be a neutral polymer network, for example, formed by polymerization of monomers being acrylic acid or derivatives thereof, preferably, acrylamide, and occasionally crosslinking by a cross-linker. For example, the neutral polymer network can give strength to the hydrogel.

In the present invention, the hydrogel having an interpenetrating polymer network may be a double-network hydrogel (DN gel). The DN gel is, for example, known as a new class of hydrogels with sufficiently higher mechanical and ion exchange properties, in which a high relative molecular mass neutral polymer network (second network) is incorporated within a swollen heterogeneous polyelectrolyte network (first network). The mechanical properties of DN gels prepared from many different polymer pairs are shown to be much better than that of the individual components. The DN gels with optimized composition, containing about 90 wt % water, possess hardness (elastic modulus of 0.1-1.0 MPa), strength (failure tensile stress 1-10 MPa, strain 1000-2000%; failure compressive stress 20-60 MPa, strain 90-95%).

Although this double network structure has been found effective to many kinds of combination, among all the polymer pairs the inventors studied so far, the one containing poly (2-acrylamido, 2-methyl, 1-propanesulfonic acid) (PAMPS) polyelectrolyte and polyacrylamide (PAAm) neutral polymer stands out due to unusually properties. The strength of DN gel increases when the molar content of the second network with respect to the first network increases. The mechanical behavior of the DN gel sufficiently changes with the variation of the cross-linker density of the second network, even if all the PAMPS/PAAm DN gels show almost the same elastic modulus, water content, and molar ratio of the second network to the first network. Recent work (Macromolecules, 2009, 42, 2184) showed that when the first PAMPS gel was synthesized, some divinyl-crosslinker-methylenebis(acrylamide) (MBAA) reacted only on one side and un-reacted double bonds were still intact in the first PAMPS gel. Therefore, when the second PAAm network was prepared, the AAm monomers of the second network could react with the remaining double bonds of the first network. Therefore, typical DN gels have inter-cross-linked (connected) double network structure, and usual DN gels reached a high strength even without adding any cross-linker of the second network by the inter-connection between the two networks through covalent bonds.

<Preparation of the Separator of the BES>

The separator of the BES of the present invention may be prepared, for example, as follows. Here, DN gel is used for the hydrogel.

First: any porous material with the porosity up to 70% may be used as a porous supporting material. The DN gel with ion-exchange properties is incorporated into the porous supporting material via the following steps;

The first net is created, for example, by using of a charged unsaturated monomer where the content of this monomer in the final double net polymer varies from 10 to 50 mol %. In the case of the cation exchange separator, the 2-acrylamido-2-methylpropane sulfonic acid (AMPS) monomer may be used to prepare the first network.

Second: an electrically neutral unsaturated monomer may be used as a second monomer component where the content of this monomer in the final double network polymer varies from 50 to 90 mol %. For cation exchange separators, the monomers like acrylamide (AAm), acrylic acid (AA), methacrylic acid, and their derivatives may be used. Here, the ratio of molar amounts of the charged monomer to the monomer being acrylic acid or derivatives thereof is from 1:1 to 1:4.

The porous supporting materials are typically not transparent for ultraviolet irradiation. Moreover the second requirement is that double net polymers of separator should swell in water. This restriction influences the choice of polymerization initiator, crosslinker, and activator and solvent.

Polymerization initiators and activators to be used for forming the first and second network structures are not limited and a variety of them may be used depending on organic monomers to be polymerized. However, a water-soluble thermal initiators such as potassium persulfate or ammonium peroxydisulfate (APS) may be preferably used as initiators in the case of thermal polymerization in combination with tetramethylethylenediamine (TEMED) as activator.

The preferable cross-linker for the present invention is N, N′-methylenebisacrylamide (MBAA). A cross-linker of an amount of 2 to 8 mol % to the charged monomers can be used preferably. A cross-linker of an amount of 0.2 to 0.8 mol % to the monomers being acrylic acid or derivatives thereof can be used preferably.

The value of conductivity can be varied, for example, by the amount of cross-linker in the first network.

The swelling property of DN hydrogels can be varied, for example, in the wide range (50%-200%). This property makes it possible to apply mechanical treatment to the porous supporting material (like ceramics) when DN hydrogel is in the dry state inside the pores of the supporting material. After treatment, the porous supporting material is immersed in the liquid phase, then, the DN hydrogel partially go out of the pores of the porous supporting material and completely cover the surface of the separator. The covering of the surface is useful for protecting the separator from pressing out of the DN hydrogel from the separator, especially when the separator is used for a reactor whose height is 1 m or more, for example, around 10-15 m. This height corresponds to the liquid pressure of 101 kP-152 kP. The variation of swelling property and rigidity of the final polymer can be controlled, for example, by the concentration of the monomer in the second network and the amount of cross-linker in the second network.

### EXAMPLES

Hereinafter, the present invention will be described in more detail with reference to examples, but the present invention is not limited by these examples.

### Example 1

In this example, BES (a microbial fuel cell) according to Embodiment 1 was manufactured.

The geometrical size of the BES (a microbial fuel cell) of Example 1 was 0.6×1.6×1.8 m³, which resulted in 1.7 m³ of the total volume inside reactor (container). Ten horizontally located plastic plates sectionalized the BES. The size of each section, which was formed by two plastic plates, was 0.6×1.6×0.14 m³. Each of the plate had a cutout in the form of rectangular strip on the one side of the plate. A liquid inlet and a liquid outlet, which are plastic tubes, were provided at the lower part on one side of the reactor and at the upper part on different sides of the reactor, respectively.

Anodic electrodes (corresponding to FIG. 1 (30)) had the form of carbon brushes with calculated specific surface area of (90±5) m²/m³. The diameter of carbon fibers in each brush was 70 mm. The length of each brush was 1800 mm.

Porous ceramic tubes which were used as separators between anodic and cathodic zones (corresponding to FIG. 1 (20)) had porosity of 50% and the sizes: Dext=84 mm, Dint=76 mm and length=1800 mm. The total number of tubes was 21, however 17 of them were in use. Four tubes were in reserve. Every ceramic tube was surrounded by 6 anodic brushes. Carbon fibers of every 6 anodic brushes had contacts with external surface of ceramic tube that they surrounded.

Porous ceramics tubes were impregnated by double net cation exchange polymer. Polymer was prepared by sequential polymerization of two types of monomers. At the first stage the 2-acrylamido-2-methylpropane sulfonic acid (AMPS) monomer was subjected to polymerization and partial crosslinking. On the second stage unsaturated monomer-acrylamide was introduced in the polymer obtained at the first stage. Then acrylamide was subjected to polymerization and partial crosslinking. The polymer is a double network hydrogel with ionic conductivity higher than commercial ion exchange membranes. The specific procedure of the preparation of porous ceramic separator with hydrogel inside the porous system is shown below.

(Solution for the First Network Gel of the Hydrogel)

A 2-acrylamido-2-methylpropane sulfonic acid (AMPS) as a first monomer was dissolved in deionized water (1M solution), then (2% M) of N,N′-methylenebisacrylamide (MBAA) as a crosslinker was added and dissolved in the previous solution, then an ammonium peroxy-disulfate (APS) (1% M) as initiator was dissolved in previous solution, and the mixture was shaken several times.

(Solution for the Second Network Gels of the Hydrogel)

Acrylamide (AAm) as a second monomer was dissolved deionized water (2 M). Then a N,N′-methylenebisacrylamide (MBAA) as a crosslinker was added and dissolved in the previous solution (0.2% M). After that ammonium peroxydisulfate (APS) as initiator (1% M) was added to the previous solution. The mixture was shaken several times.

(Preparations of the Cation Exchange Separators)

Each ceramic tube was placed inside the polymerization reactor which represented a polymeric tube with one end. Ceramic tube was completely was covered by appropriate solution for the first network gel. Then the reactor was put into oven at the temperature of 60° C. for 24 hours.

Then, the solution for the second network gels was introduced in the polymerization reactor, which contained ceramic tube impregnated by the first polymer net, in such a way that the solution with second monomer completely covered the surface of ceramics. Then, the reactor was left for 24 hours. Penetration of the solution for the second network gel into the structure of the first polymer located in the pores of ceramic tube occurs. After one day of penetration of the second monomer inside the first polymer, the reactor with the ceramic tube was put into oven at the temperature of 60° C. for 24 hours.

The catalyst (corresponding to FIG. 2 (41)) for cathodic oxygen reduction reaction was prepared using iron(III) nitrate and urea as precursors. The supporting material was granules of activated carbon. Specifically, a mixture of precursors in water with the molar ratio iron(III) nitrate/urea 5:1 is prepared. After impregnation of granules of activated carbon by this mixture, the granules were heat treated at the optimal temperature 700° C.

The internal (faced to air) part of the separator had diameter 74 cm whilst the thickness of the hydrogel inside the separator was 4 mm. The internal part of the separator was covered by the cathode (collector of electricity part) which represented a carbon cloth. The upper part of the cathode (collector of electricity part) had a clip for installation of external resistance of the BES. The above catalyst was mechanically attached to the air-faced surface of the carbon cloth by means of a polymeric net.

Ventilation of internal part of cathodic tubes (the separator and the cathode) was done by means of 2 fans located on the upper lid of top-box (corresponding to FIG. 1 (61)). The fans were able to produce linear rate of air flow in each cathode more than 10 cm/sec.

The sprayer that was used was a commercial sprayer widely used for wetting of the ground in gardens. It had sphere small holes on the surface of the sprayer head. Application of water pressure inside the sprayer produced jets in different directions.

<Test 1>

Influence of the number of cathodic elements, connected in parallel, on the electrical parameters of the BES of Example 1.

BES was inoculated by activated sludge taken from food wastewater treatment plant in food factory. The wastewater that was treated was rice wash water.

TABLE 1
The parameters of the medium at the inlet

| Parameter | Units mg/L |
|---|---|
| BOD | 3710 |
| pH | 5.2 |
| NO3 | 0.005 |
| PO4-P | 114 |

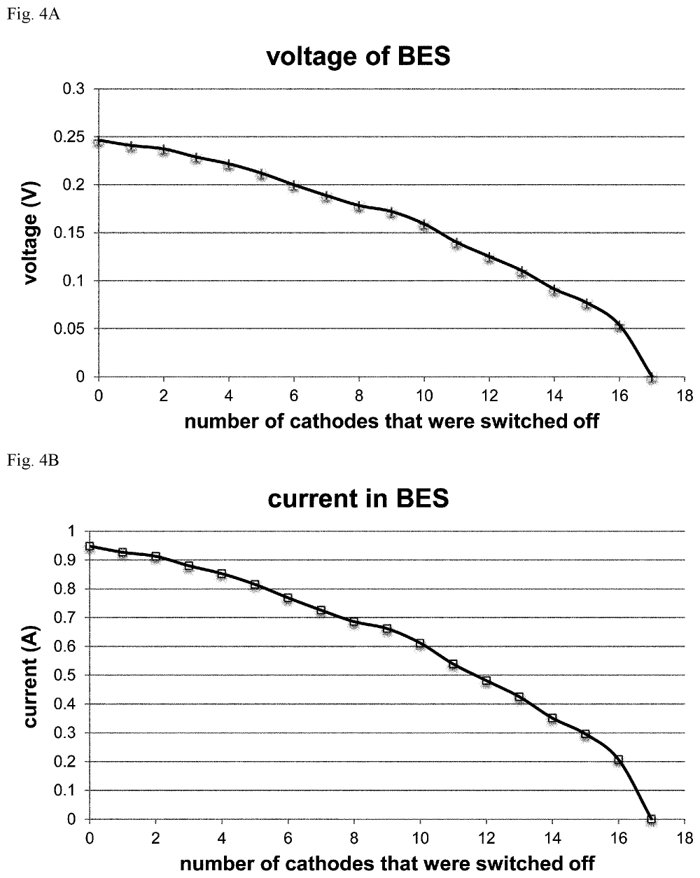

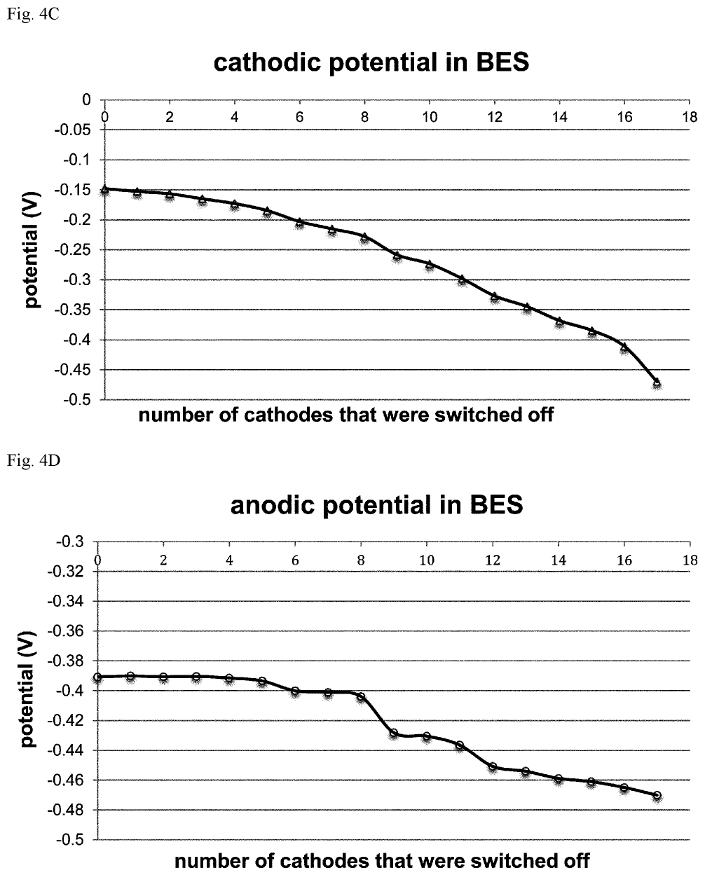

This test shows how the decrease of the number of cathodes influences on current and voltage of the BES. At the beginning of the test all cathodes and anodes were connected in series. The external resistance of 0.25 Ohm was introduced as external load. The system was stabilizing during one day. Then by means of disconnecting of one by one the number of cathodes was decreased and parameters of BES were recorded. The time interval between disconnecting was 5 minutes. The results are shown on FIG. 4 (A, B, C, D). In present test all cathodic tubes had open ends, which means that they worked in gas-diffusion mode. No forced ventilation (two fans) was applied.

The results of Test 1 indicate that the present BES which had the volume 1.7 m³ can successfully work and has high performance as a BES.

<Test 2>

Ammonia removal using the BES of Example 1.

The capability of the BES of Example 1 for ammonia removal through the porous ceramic tubes filled with polymer was investigated.

In Test 2, the BES was inoculated by activated sludge taken from food wastewater treatment plant in food factory. The wastewater that was treated was rice wash water. Ammonia concentration was measured by kit: TNT-833 (Hach corporation). The cathodes worked in gas diffusion mode.

(Test 2-1)

For that 17 cathodic tubes was electrically connected in parallel and the BES worked in batch feeding mode with wastewater, which contained nitrogen-containing compounds, for at least 2 months. The external resistance that was applied was 0.25 Ohms. Ammonia transport from anodic to cathodic zones was a part of the whole cationic transport.

To remove compounds that accumulated in previous working, the water-soluble substances that appeared on the surface of air cathode faced to air were washed out by the sprayer of the BES during 30 seconds. Then the procedure of washing out was repeated during the same 30 seconds. After the second procedure, a sample of water solution was collected and the concentration of ammonia was measured. The residual value of ammonia was 3.5 mg/L. The pH of the sample was 8.02.

The result of Test 2-1 indicates the present BES can work efficiently for ammonia removal.

(Test 2-2)

Three tests (Tests 2-2a, 2-2b, 2-2c) were carried out. In Test 2-2a, ammonia flux was driven by the gradient of chemical potential (gradient of concentration). In Tests 2-2b and 2-2c, ammonia flux was driven by the gradient of electrochemical potential (diffusion and migration of ions). In the Tests, two groups (each group includes 4 cathodic tubes) were chosen for evaluating the test result. The concentration of ammonia was averaged for each group.

(Test 2-2a)

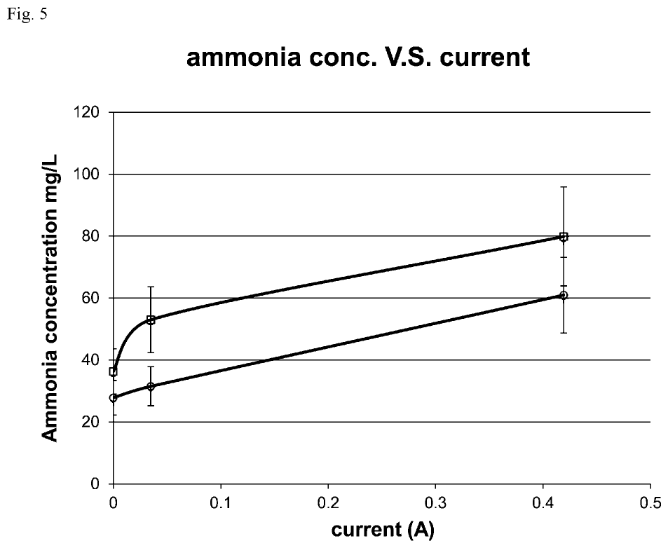

An open circuit mode was applied to BES during 1 hour. In this mode ammonia diffused from anodic zone to the inner surface of cathodic electrode through an ion exchange polymer. Then the water soluble substances that appeared on the surface of air cathode faced to air was washed out by the sprayer of the BES during 30 seconds. After that, samples of water solution were collected and the concentration of ammonia was measured. The results for 2 groups of cathodic tubes are shown on FIG. 5 (the values when the current was equal to zero). This concentration of ammonia was compared with the concentration of ammonia inside anodic zone of the BES. It appeared that the concentration of ammonia in anodic zone was 30 mg/L which was quite near to the average concentration of ammonia on the surface of ion-exchange polymer faced to cathode, 32 mg/L (see FIG. 5 Current=0 A).

(Test 2-2b)

Having completed Test 2-2a, the cleaning procedure (as described above) was applied the air faced cathodic surface before Test 2-2b. Contrary to Test 2-2a in present test, the BES was loaded with external resistance of 11 Ohm. The feeding conditions were the same as in Test 2-2a. The current generating mode was applied during 1 hour. Then the water soluble substances that appeared on the surface of air cathode faced to air was washed out by the sprayer of the BES during 30 seconds. After that, two samples of water solution were collected and the concentration of ammonia was measured. The results for 2 groups of cathodic tubes are shown on FIG. 5.

(Test 2-2c)

Having completed Test 2-2b, the cleaning procedure (as described above) was applied the air faced cathodic surface before Test 2-2c. Contrary to Test 2-2b in present test, the BES was loaded with external resistance of 1 Ohm. The feeding conditions were the same as in Tests 2-2a, 2-2b. The current generating mode was applied during 1 hour. Then the water soluble substances that appeared on the surface of air cathode faced to air was washed out by the sprayer of the BES during 30 seconds. After that, two samples of water solution were collected and the concentration of ammonia was measured. The results for 2 groups of cathodic tubes are shown on FIG. 5.

This test shows that the present BES can be as efficient for ammonia removal from wastewater. In all tests cathodes worked in gas diffusion mode.

The result of Test 2-2 indicates the higher voltage of the BES leads to the higher ammonia flux through a cation exchange hydrogel, and as a consequence, the higher ammonia removal from anodic zone.

<Test 3>

Investigation of treatment efficiency (TE) of the BES of Example 1 at different organic loading rates (OLR).

Test 3 includes testing of TE of the BES at different OLR. The parameter TE was calculated using formula 1, while OLR was calculated using formula 2.

In Test 3, the BES was inoculated by activated sludge taken from food wastewater treatment plant in food factory. The wastewater that was treated was rice wash water. COD concentration was measured by kit: TNT-823 Hach corporation.

TE (%)=(1−Cout/Cin)*100 (formula 1)

Where Cout and Cin are outlet and inlet concentration of organics in wastewater.

OLR (g/L/day)=Cin/HRT (formula 2)

Where HRT (days) is hydraulic retention time of liquid phase in BES.

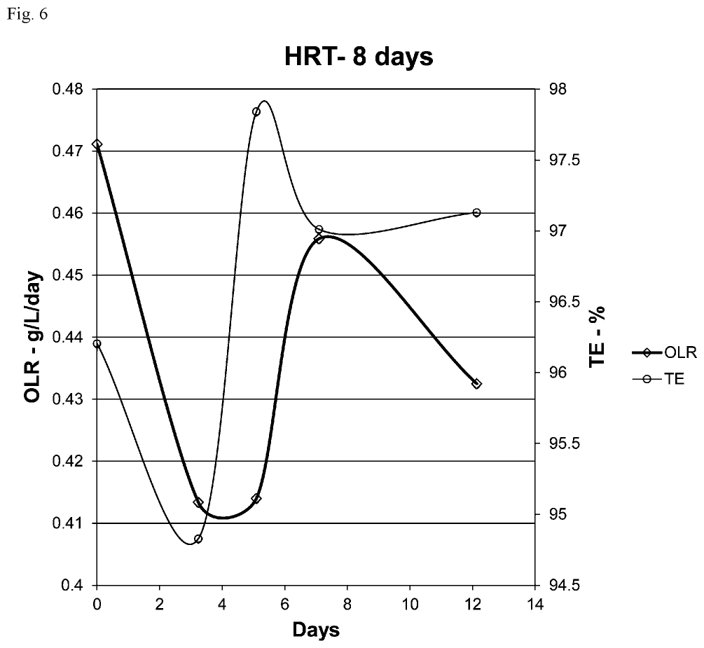

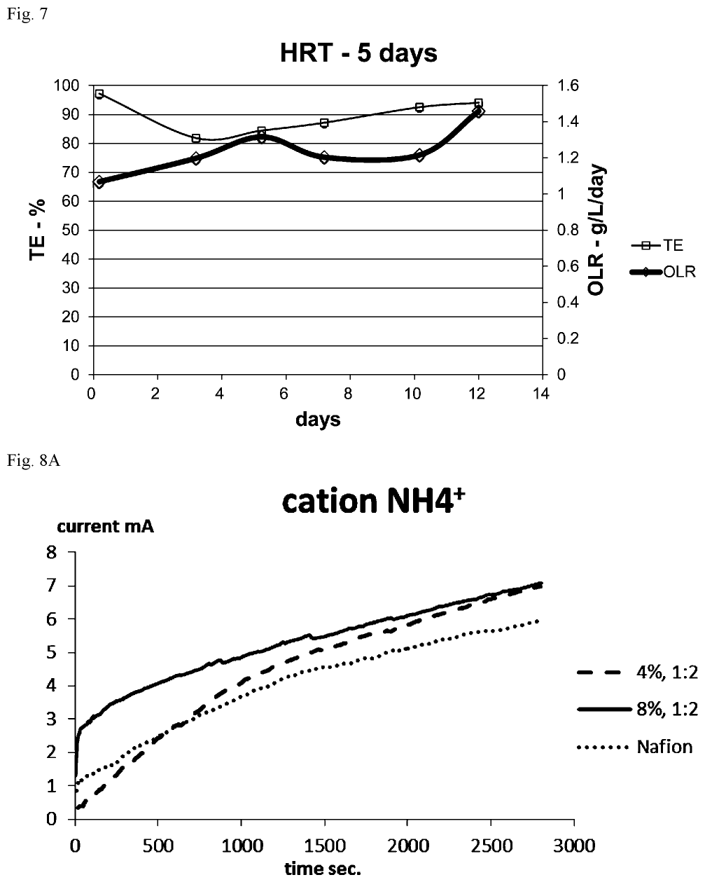

The volume of the BES of Example 1 was 1.7 m³ as described above. The substrate was rise wash from distillery plant. The inlet pH was around 5. Two values of HRT were tested: HRT=8 days and HRT=5 days. The results are shown on FIG. 6 and FIG. 7.

### Reference Example

In this reference example, the separators used for the BES were manufactured and the performance of them were examined.

All chemicals were purchased from WACO Pure Chemicals; Potentiostate “INTERFACE 1000E” manufactured by GAMRY INSTRUMENTS company (USA) was used for chronoamperometry method. Comparative tests were carried out using membrane Nafion™ (DuPont corporation USA) for comparison with DN cation exchange polymers.

<General Description of Electrochemical Tests and Grouping of Results>

Porous Supporting Materials, Polymerization Reactor and Electrochemical Cell for Testing

The porous supporting material for ion exchange separators were plates of porous ceramics of 50% porosity (Jiangso Ceramic, China) and plates of porous plastic of 70% porosity (Yamahachi Chemical, Japan). The size of all plates was 97 mm×75 mm×3.3 mm.

The polymerization reactor was made from acrylic glass with the thickness of the 8 mm wall thickness. The internal volume has rectangular shape with the height of 50 mm and the bottom area of 100 mm×80 mm. The upper lid of the reactor had 2 taps for filling of reactor with nitrogen gas and oxygen removal.

The electrochemical cell for testing of separators has two chambers in the form of hollow cylinder with one closed side and an open opposite side with a flange at the end. The aperture of the flange was equal to the external diameter of the cylinder. Each flange had a rubber ring glued to the surface of the last one. The volume of each chamber was 50 mL. Each chamber contained stainless steel electrode in the form of cylinder (length 4 cm, diameter 0.4 cm). The aperture of each flange was 20 cm².

In the case of test for cation exchange separators, each chamber has identical (length 5 cm, diameter 0.5 cm) stainless steel electrodes. Each chamber also has an orifice for reference electrode and for filling appropriate electrolyte solution. The ion exchange separator was pressed between rubber rings located on each flange.

The result of each electrochemical test was a curve which represented dynamics of a current in time for each ion. Tests for different separators with different hydrogels were grouped. One contained different current curves obtained for one ion. Reference separators with commercial membranes contained one curve for each ion.

1. Cation Exchange Separators (Separators 1-3)

(Preparations of the Solutions for Hydrogels)

Solution for the First Network Gel of the Hydrogel (Used for Separator 1, Polymer with 2% M Crosslinker)

14 mL of deionized water at 4° C. as a solvent were purged with nitrogen gas for deoxygenation for 15 minutes. Then 2.9 gram of 2-acrylamido-2-methylpropane sulfonic acid (AMPS) as a first monomer was dissolved in 14 mL of deionized water (1M solution), then 43 mg (2% M) of N,N′-methylenebisacrylamide (MBAA) as a crosslinker was added and dissolved in the previous solution, then 32 mg of ammonium peroxy-disulfate (APS) (1% M) as initiator was dissolved in previous solution, then 40 microliters of tetramethylethylenediamine (TEMED) as activator was added to the previous solution and the mixture was shaken several times.

Solution for the First Network Gel of the Hydrogel (Used for Separator 2, Polymer with 4% M Crosslinker)

14 mL of deionized water at 4° C. as a solvent were purged with nitrogen gas for deoxygenation for 15 minutes. Then 2.9 gram of 2-acrylamido-2-methylpropane sulfonic acid (AMPS) as a monomer was dissolved in 14 mL of deionized water (1M solution), then 86 mg (4% M) of N,N′-methylenebisacrylamide (MBAA) as a crosslinker was added and dissolved in the previous solution, then 32 mg of ammonium peroxy-disulfate (APS) (1% M) as initiator was dissolved in previous solution, then 40 microliters of tetramethylethylenediamine (TEMED) as activator was added to the previous solution and the mixture was shaken several times.

Solution for the First Network Gel of the Hydrogel (Used for Separator 3, Polymer with 8% M Crosslinker)

14 mL of deionized water at 4° C. as a solvent were purged with nitrogen gas for deoxygenation for 15 minutes. Then 2.9 gram of 2-acrylamido-2-methylpropane sulfonic acid (AMPS) as a monomer was dissolved in 14 mL of deionized water (1M solution), then 172 mg (8% M) of N,N′-methylenebisacrylamide (MBAA) as a crosslinker was added and dissolved in the previous solution, then 32 mg of ammonium peroxy-disulfate (APS) (1% M) as initiator was dissolved in previous solution, then 40 microliters of tetramethylethylenediamine (TEMED) as activator was added to the previous solution and the mixture was shaken several times.

Solution for the Second Network Gel

14 mL of deionized water at 4° C. were deoxygenation by purging with N₂ gas for 15 minutes. 2 grams of acrylamide (AAm) as a second monomer was dissolved in 14 mL of deionized water (2 M). Then 10 mg of N,N′-methylenebisacrylamide (MBAA) as a crosslinker was added and dissolved in the previous solution (0.2% M). After that 32 mg of ammonium peroxydisulfate (APS) as initiator and 40 microliters of tetramethylethylenediamine (TEMED) as activator was added to the previous solution.

(Preparations of the Cation Exchange Separators (Separators 1-3))

Each flat ceramic plate was placed on the bottom of polymerization reactor and completely covered by appropriate solution for the first network gel. Then the reactor was put into oven at the temperature of 60° C. for 24 hours. Thus, three ceramic plates, which contained three different first network gels, were prepared.

Then, the solution for the second network gels was introduced in the polymerization reactor, which contained ceramic plate impregnated by the first polymer net, in such a way that the solution with second monomer completely covered the surface of ceramics. Then, the reactor was left for 24 hours. Penetration of the solution for the second network gel into the structure of the first polymer located in the pores of ceramic plate occurs.

These hydrogels were prepared with a molar ratio of the first net to second net as 1/2.

(Electrochemical Tests of Cation Exchange Separators)

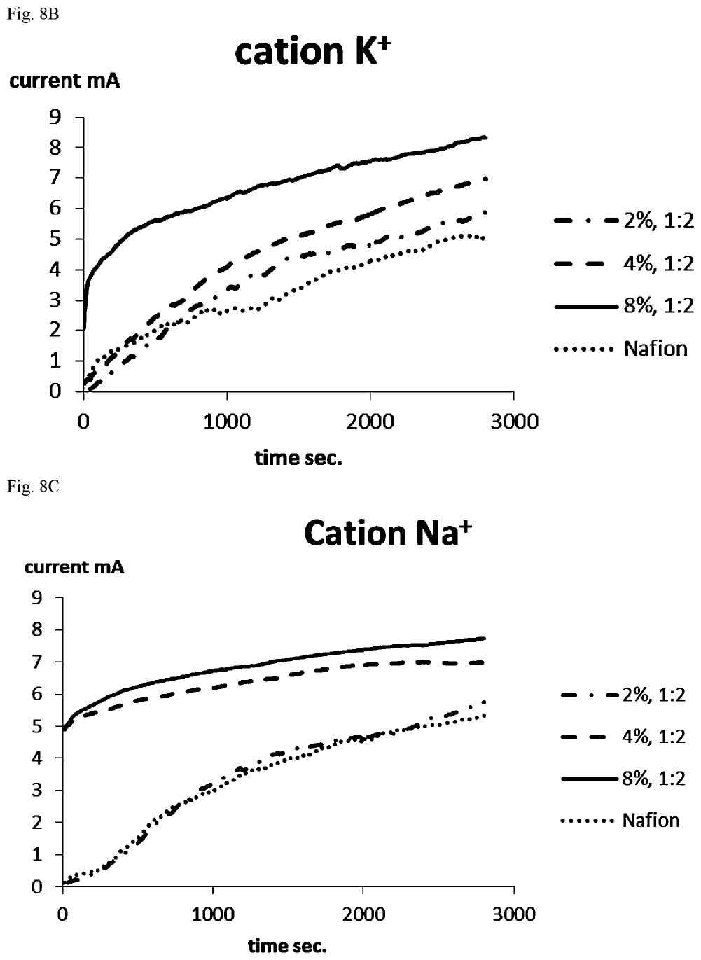

Before testing each separator was pressed between rubber rings located on the surface of flanches of cylinder. Then both cylinders were filled with appropriate electrolyte and chronoamperometry method was applied for comparison of the currents corresponding to the fluxes of different cations thru separator. Chronoamperometry was realized using two electrode system where the voltage between anodic and cathodic electrode was equal to 0.5V. Three types of electrolytes were used: 0.1M NH₄Cl in deionized water concentration (FIG. 8A), 0.1M KCl in deionized (FIG. 8B), 0.1M NaCl in deionized water concentration (FIG. 8C).

Cation exchange polymers (Separators 1-3) were prepared as described above. They differ only by concentration of cross-linker in the first network gel. The amounts of cross-linker in the first net were 2% M, 4% M, and 8% M with respect to the concentration of 100% M of initial charged monomers. All components in the second network were identical in all three separators. The molar ratio of the monomers in the first net to the monomers in the second net was 1M/2M.

Reference separators 1-3 for the same three types of electrolytes were created. The electrochemical cell was the same as in Separators 1-3. The cell contained porous ceramics plate of 50% porosity, identical to ceramic plates that were used as supporting materials for Separators 1-3. One side of the plate was covered by foliate-type ion exchange membrane—Nafion 117.

FIGS. 8A-C contain information about the values of currents generated by different cations and for different separators (Separators 1-3 and Reference separators 1-3). Legends to figures on FIGS. 8A-C show the molar percentage of cross-linker and molar ratio of the first monomer to the second one. As shown in FIG. 8A-C, currents for Separators 1-3 are higher in comparison with Reference separator (with widely used cation exchange membrane Nafion-117).

2. Microbial Fuel Cell Internal Resistance Tests.

Internal resistances of microbial fuel cell with two different separators were measured by means of liner sweep voltammetry.

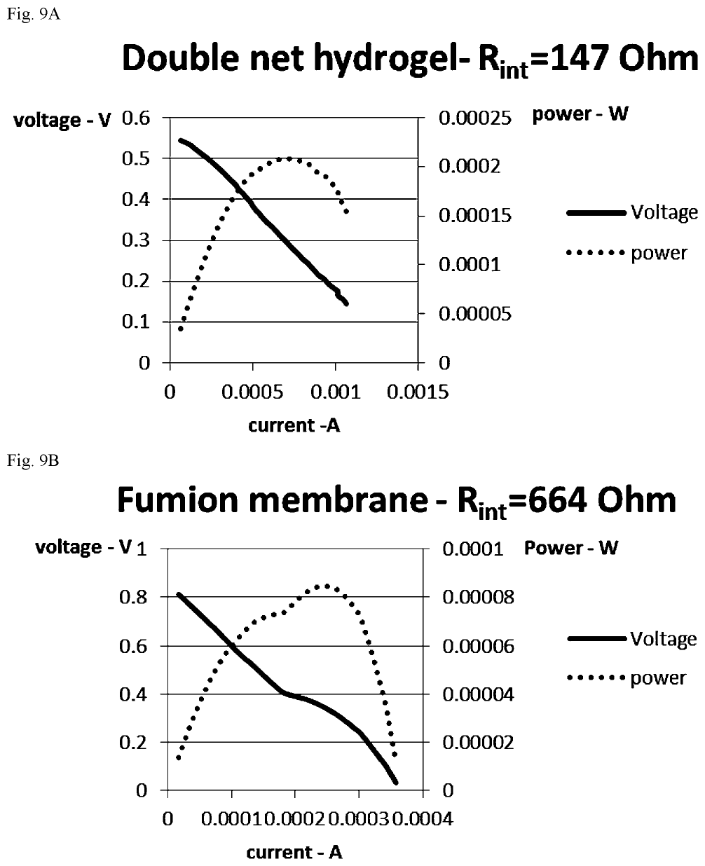

The microbial fuel cell for this test consisted of one anodic chamber which had the volume 150 mL, inoculated with anaerobic sludge, and two identical air breezing cathodic electrodes attached to both sides of anodic chamber. The first cathodic electrode was separated from anodic zone by means of the separator (Separator 4, FIG. 9A) based on cation exchange hydrogel impregnated in porous ceramic plate whilst the second cathodic electrode was separated from the same anodic zone by the separator which was porous graphite plate of the same size covered by cation exchange polymer Fumion™, which is an analog of Nafion-117 (Reference separator 4, FIG. 9B).

(Measurement of Internal Resistances of Separator 4 and Reference Separator 4)

To produce Separator 4, a cation exchange separator (ceramic plate 60×80×3 mm³, 50% porosity impregnated by double net hydrogel) was created by the same way as in Separator 1 where the molar ratio of the first (charged) monomer to the second (uncharged) monomer was 1:2 and the concentration of cross-linker in the first net was 2%.

For Reference separator 4, a porous graphite plate 60×80×3 mm³ (50% porosity) was covered by liquid suspension of ion exchange polymer with the following drying (5% solution of ion exchange polymer—Fumion™ in water (company Fumatech—Germany)). The density of covering was 2 mL suspension per 1 cm² of the plate surface.

The information about internal resistances for Separator 4 and Reference separator 4 was taken from polarization curves (voltage vs current). Polarization curves were obtained by linear voltammetry using two electrode system. The sweep rate was 0.01 mV/sec. This sweep rate gave the possibility to keep microbial fuel cell in cvazy-equilibrium state at different values of applied voltage. The obtained experimental voltamograms and calculated power curves are shown on FIG. 9A-B. The internal resistances for both separators were calculated using the formula 3:

Rᵢₙₜ=V_{Pmax}/I_{Pmax}/2 (formula 3)

Where: V_{Pmax}—voltage for the maximal power generation of microbial fuel cell,

I_{Pmax}—current for the maximal power generation of microbial fuel cell

Factor 2 appeared in the formula because the maximal power is generated when the external resistance generated by potentiostate is equal to internal one.

As it follows from the curves on FIGS. 9A-B and the formula, the internal resistance for the case when anodic and cathodic zones were separated by Separator 4 was 4.5 times less than for the case when zones were separated by Reference separator 4. The values of internal resistances were 147 Ohms and 664 Ohms respectively.

### REFERENCE SIGNS LIST

1 BES
10 container
10a upper lid
10b bottom part of container
10c hole
11 partition plate
11a window
12 liquid inlet
13 liquid outlet
20 tube shaped separator
21 holder
22 polymeric net
23 nonconductive ring
24 nonconductive net
30 anode
31 electrical output of anodic electrode
40 cathode
41 catalyst
50 wetting unit
51 pipe
52 cap
60 oxygen supplying unit
61 air collector
62 fan
63 hollow tube

1. A bio electrochemical system for the treatment of organic liquid wastes, which comprises:
a container;
at least one tube shaped separator vertically disposed such that it penetrates the container;
at least one anode disposed in the external space of the tube shaped separator;
at least one cathode disposed in the interior space of the tube shaped separator; and
at least one partition plate horizontally disposed such that it forms multistage horizontal flow channels for organic liquid wastes in the container.

2. The bio electrochemical system according to claim 1, wherein the cathode is an air cathode.

3. The bio electrochemical system according to claim 1, wherein the cathode is disposed in contact with the inner surface of the tube shaped separator.

4. The bio electrochemical system according to claim 1, wherein the anode is disposed vertically such that it crosses the multistage horizontal flow channels.

5. The bio electrochemical system according to claim 1, which further comprises a liquid inlet and a liquid outlet.

6. The bio electrochemical system according to claim 1, which further comprises a wetting unit for the cathode.

7. The bio electrochemical system according to claim 1, which further comprises an oxygen supplying unit for the cathode.

8. The bio electrochemical system according to claim 1, wherein the volume of the container is more than 1 m³ and the shape of the container is parallelepiped.

9. The bio electrochemical system according to claim 1, wherein upper lid and bottom part of the container have holes for installation of the tube shaped separator.

10. The bio electrochemical system according to claim 1, wherein the partition plate contains a hole for keeping the tube shaped separator and the anode in vertical position, wherein the partition plate has a window for entering of the liquid from one flow channel to the next flow channel.

11. The bio electrochemical system according to claim 10, which comprise two or more of the partition plate with a window formed against one wall of the container, wherein the wall surface on which the window of one of the partition plate is formed and the wall surface on which the window of the other partition plate disposed next to the partition plate is formed are in an opposing relationship.

12. The bio electrochemical system according to claim 10, wherein all edges, except window edges, of the partition plate have water proof contact with all four walls of the container.

13. The bio electrochemical system according to claim 1, which further comprises a catalyst attached to the cathode.

14. The bio electrochemical system according to claim 13, wherein the catalyst consists of a porous electrically conductive support material covered by a catalytically active compound containing atom of transition metals.

15. The bio electrochemical system according to claim 14, wherein the porous electrically conductive support material is a granule of carbon-based material.

16. The bio electrochemical system according to claim 15, wherein the granule of carbon-based material is a highly porous granule of activated carbon.

17. The bio electrochemical system according to claim 13, wherein the catalytically active compound is represented by the general formula [Metal]ₓ[Nitrogen]_{y}[Carbon]_{z}.

18. The bio electrochemical system according to claim 1, wherein the tube shaped separator comprises a porous supporting material and a cation exchange material.

19. The bio electrochemical system according to claim 18, wherein the porous supporting material is a nonconductive porous material.

20. The bio electrochemical system according to claim 1, wherein the tube shaped separator is cylindrical.

21. The bio electrochemical system according to claim 1, wherein the tube shaped separator has two open ends.

22. The bio electrochemical system according to claim 18, wherein the cation exchange material is a cation exchange polymer.

23. The bio electrochemical system according to claim 18, wherein the cation exchange material is introduced in pores of the porous supporting material.

24. The bio electrochemical system according to claim 22, wherein the cation exchange polymer is a polymer selected from the group consisting of Nafion™ type polymers, Fumion™ type polymers and a double network hydrogel which contains negatively charged groups.

25. The bio electrochemical system according to claim 1, wherein the cathode is a soft conductive material selected from the group consisting of carbon tissue, carbon felt and carbon paper.

26. The bio electrochemical system according to claim 1, wherein the cathode is attached to the inner surface of the tube shaped separator.

27. The bio electrochemical system according to claim 1, wherein the catalyst is attached to the air faced surface of the cathode.

28. The bio electrochemical system according to claim 13, wherein the wetting unit periodically wets the cathodes with electrolyte such that a wet contact between the inner surface of the tube shaped separator and the cathode and a wet contact between the cathode and the catalyst are maintained.

29. The bio electrochemical system according to claim 13, wherein the wetting unit comprises a pipe for supplying electrolyte and a cap having a sprayer for spraying the supplied electrolyte,
wherein the sprayer introduces the electrolyte only to the inner surface of the tube shaped separator.

30. The bio electrochemical system according to claim 29, wherein the cap having the sprayer is located at the top point of the tube shaped separator, wherein
the sprayed electrolyte forms a wall flow near the inner surface of the tube shaped separator using the cathode as a guiding element and comes down to the bottom point by gravity.

31. The bio electrochemical system according to claim 7, wherein the oxygen supplying unit comprises an air collector and an airflow stimulator.

32. The bio electrochemical system according to claim 31, wherein the air collector is box shaped and is disposed such that it covers the top of all the tube shaped separators, wherein
the bottom part of the air collector collects gas from the inside of the tube shaped separator.

33. The bio electrochemical system according to claim 32, wherein the airflow stimulator is a fan which disposed either on the side walls or on the top of the box shaped air collector.

34. The bio electrochemical system according to claim 32, wherein the air flow stimulator is a hollow tube of at least 6 times higher than the height of the container with open ends, wherein
the hollow tube stands vertically on the top of the air collector and communicates with the air collector at one end.

35. The bio electrochemical system according to claim 1, wherein anode comprises a conductive core with or without a carbon based element attached to the conductive core.

36. The bio electrochemical system according to claim 35, wherein the anode comprises at least one selected from the group consisting of a stainless steel rod, a stainless steel brush, a carbon rod, and a carbon brush.

37. The bio electrochemical system according to claim 1, wherein at least one of the anodes is disposed on the outer surface of the tube shaped separator with no gap.

38. The bio electrochemical system according to claim 37, wherein at least one of the anodes is reeled up on a part of the outer surface of the tube shaped separator.

39. The bio electrochemical system according to claim 37, wherein at least one of the anodes is in the form of straight line.
